(19) United States
(12) Patent Application Publication
(10) Pub. No.: US 2026/0286910 A1
(43) Pub. Date: Sep. 24, 2026

(54) APPARATUS AND METHOD FOR DIAGNOSING AN ENGINE SYSTEM

(71) Applicants: HYUNDAI MOTOR COMPANY, SEOUL (KR); KIA CORPORATION, SEOUL (KR)

(72) Inventor: Bon Chang Koo, Hwaseong-si (KR)

(73) Assignees: HYUNDAI MOTOR COMPANY, SEOUL (KR); KIA CORPORATION, SEOUL (KR)

(21) Appl. No.: 19/421,267

(22) Filed: Dec. 16, 2025

(30) Foreign Application Priority Data
Mar. 24, 2025 (KR) 10-2025-0037132

(51) Int. Cl. F02D 41/22

(52) U.S. Cl. CPC F02D 41/22; F02D 2200/023; F02D 2200/0414; F02D 2200/501

(57) ABSTRACT

An apparatus of diagnosing an engine system of a vehicle includes: a state information detection portion that detects state information of the vehicle; a diagnostic condition determination portion that determines whether an entry condition diagnosing the engine system is satisfied based on the state information; an ignition efficiency calculation portion that determines an ignition efficiency diagnosis index by dividing an ignition efficiency control difference average while an engine is in an idle state by an ignition efficiency control target average while the engine is in the idle state when an idle time of the engine is maintained for 1 hour or more after the engine is started; and a fault diagnosis portion that determines that the engine system is abnormal when the ignition efficiency diagnosis index is less than a set fault diagnosis reference value.

### CROSS REFERENCE TO RELATED APPLICATIONS

This application claims priority to and the benefit of Korean Patent Application No. 10-2025-0037132 filed with the Korean Intellectual Property Office on Mar. 24, 2025, the entire contents of which are incorporated herein by reference.

### BACKGROUND

### (a) Technical Field

The present disclosure relates to a diagnostic apparatus and a diagnostic method for an engine system. More particularly, the present disclosure relates to an apparatus and a method for an engine system that diagnoses whether components that increase an exhaust gas during cold start of a vehicle are faulty.

### (b) Description of the Related Art

Generally, cold start emission reduction (CSER) of a vehicle refers to reducing an amount of an exhaust gas released into the air when an engine is first started. The exhaust gas may include carbon monoxide (CO), nitrogen oxide (NOₓ), and a particulate matter (PM).

A conventional vehicle uses a separate catalyst heating (C/H) strategy for a variable valve timing (VVT), an injector, ignition, an revolutions per minute (RPM), and environmental working group (EWGA) of an engine to reduce a cold start emission, and performs fault diagnosis on each individual component (e.g., part).

North America's enhanced emission regulation (e.g., ACC-2 regulation) requires diagnosis of fault of an engine system that performs catalyst heating (C/H) control.

Accordingly, although conventional approaches perform fault diagnosis for individual components, in an engine, faults (e.g., failures, abnormality, or the like) may occur not only at the individual component in the engine, but also between two or more parts that are interrelated or overlap in function. Therefore, if each component is faulty and the components affect each other so that catalyst heating (C/H) is not performed normally, faults that increase the exhaust gas may occur, and a fault diagnosis method for addressing such faults may be needed.

The above information disclosed in this Background section is only to enhance understanding of the background of this disclosure. Therefore, the Background section may include information that does not form the prior art that is already known to a person having ordinary skill in the art.

### SUMMARY

An embodiment of the present disclosure provides an apparatus for diagnosing an engine system and a method thereof that perform fault diagnosis on parts (e.g., components) applied to an engine to reduce an exhaust gas (e.g., exhaust emission) during cold start of a vehicle, determine a diagnostic index of ignition efficiency when a set condition including an off time of the engine is satisfied, and compare the diagnostic index of the ignition efficiency with a fault diagnosis reference value to determine whether there is fault.

An apparatus of diagnosing an engine system of a vehicle according to an embodiment of the present disclosure is provided. The apparatus includes: a state information detection portion configured to detect state information of a vehicle; and a diagnostic condition determination portion configured to determine whether an entry condition diagnosing the engine system is satisfied based on the state information. The apparatus further includes an ignition efficiency calculation portion configured to determine an ignition efficiency diagnosis index by dividing an ignition efficiency control difference average while an engine is in an idle state by an ignition efficiency control target average while the engine is in the idle state when an idle time of the engine is maintained for 1 hour or more after the engine is started. The apparatus further includes a fault diagnosis portion configured to determine that the engine system is abnormal when the ignition efficiency diagnosis index is less than a set fault diagnosis reference value.

The state information may include an off time of the engine, an outdoor air temperature, a coolant temperature of the engine, a shift stage, a speed of the vehicle, and a load of the engine.

The diagnostic condition determination portion may be further configured to start diagnosis of the engine system when the off time of the engine is greater than or equal to a set time, the outdoor air temperature at a start of the engine is greater than or equal to a first set temperature, the coolant temperature of the engine is greater than the outdoor air temperature, the coolant temperature of the engine is less than or equal to a second set temperature than the outdoor air temperature, the engine is in the idle state, the speed of the vehicle is less than or equal to a set speed, and the load of the engine is less than or equal to a set torque.

The ignition efficiency calculation portion may be further configured to determine an ignition efficiency control difference by subtracting a current ignition timing efficiency from an ignition timing efficiency during warm-up of the engine. The ignition efficiency calculation portion may be further configured to determine the ignition efficiency control difference average during the idle state of the engine by dividing the ignition efficiency control difference by an idle maintenance time.

The ignition efficiency calculation portion may be further configured to determine an ignition efficiency control target by subtracting a target ignition timing efficiency from an ignition timing efficiency during warm-up of the engine. The ignition efficiency calculation portion may be further configured to determine the ignition efficiency control target average during the idle state of the engine by dividing the ignition efficiency control target by an idle maintenance time.

The fault diagnosis portion may be further configured to determine that the engine system is faulty when the ignition efficiency diagnosis index is less than the fault diagnosis reference value, and determine that the engine system is normal when the ignition efficiency diagnosis index is greater than or equal to the fault diagnosis reference value.

A method of diagnosing an engine system of a vehicle according to an embodiment of the present disclosure is provided. The method includes: determining, by a controller, whether an entry condition diagnosing the engine system is satisfied based on state information of a vehicle; executing, by the controller, a diagnostic logic diagnosing the engine system when the entry condition is satisfied and an idle time after an engine is started exceeds a first time; and determining, by the controller, an ignition efficiency diagnosis index by dividing an ignition efficiency control difference average while the engine is in an idle state by an ignition efficiency control target average while the engine is in the idle state. The method further includes determining, by the controller, that the engine system is abnormal when the ignition efficiency diagnosis index is less than a set fault diagnosis reference value.

When an off time of the engine is greater than or equal to a set time, an outdoor air temperature is greater than or equal to a first set temperature, a coolant temperature of the engine is greater than the outdoor air temperature, the coolant temperature of the engine is less than or equal to a second set temperature than the outdoor air temperature, the engine is in the idle state, a speed of the vehicle is less than or equal to a set speed, and a load of the engine is less than or equal to a set torque, the entry condition may be determined to be satisfied.

The diagnostic logic may be terminated when the idle time does not exceed the first time.

The determining of the ignition efficiency diagnosis index may include determining an ignition efficiency control difference average during the idle state by dividing a value obtained by subtracting a current final ignition timing efficiency from an ignition timing efficiency during warm-up of the engine by an idle maintenance time. Additionally, the determining of the ignition efficiency diagnosis index may include determining an ignition efficiency control target average during the idle state by dividing a value obtained by subtracting a final heating ignition timing efficiency target value from the ignition timing efficiency during the warm-up of the engine by the idle maintenance time.

The determining of the ignition efficiency diagnosis index may further include: determining the ignition timing efficiency during the warm-up of the engine by dividing an ignition timing during the warm-up of the engine by an ignition timing at maximum brake torque; determining the current final ignition timing efficiency by dividing a current ignition timing by the ignition timing at the maximum brake torque; and determining the final heating ignition timing efficiency target value by dividing a target ignition timing by the ignition timing at the maximum brake torque.

The determining that the engine system is abnormal may include determining that the engine system is abnormal and providing an alarm to a driver when a second time longer than the first time elapses after the engine is started.

The engine system may be determined to be normal when the ignition efficiency diagnosis index is greater than or equal to the fault diagnosis reference value.

According to an embodiment, it is possible to determine whether there is fault by calculating a diagnostic index of ignition efficiency according to catalyst heating control during cold start of a vehicle. Thus, even when there is no fault of an individual part, there may be an effect of being able to diagnose fault (or abnormality) between two or more parts of an engine system.

Additionally, fault diagnosis may be performed only when various stabilization conditions of the vehicle including an off time of an engine are satisfied. Thus, there may be an effect of preventing misdiagnosis due to a disturbance factor.

Additionally, it is possible to provide a self-diagnosis logic of the engine system that performs catalyst heating control during the cold start. Thus, there may be an effect of coping with enhanced emission regulation (ACC-2).

### BRIEF DESCRIPTION OF THE FIGURES

FIG. 1 schematically illustrates a configuration of an engine system according to an embodiment.

FIG. 2 illustrates an example of delay control of an ignition timing during catalyst heating according to an embodiment.

FIG. 3 illustrates a diagnostic configuration of a cold start emission reduction (CSER) system of a controller according to an embodiment.

FIG. 4 is a graph describing ignition timing during an idle state for diagnosing of an engine system according to an embodiment.

FIGS. 5 to 7 are flowcharts illustrating a method of diagnosing a cold start emission reduction (CSER) system according to an embodiment.

### DETAILED DESCRIPTION

The terminology used herein is for the purpose of describing particular embodiments only and is not intended to be limiting of the present disclosure. As used herein, singular forms are intended to include plural forms as well unless the context clearly indicates otherwise. It should be further understood that the terms “comprises” and/or “comprising” when used in this specification specify the presence of stated features, integers, steps, operations, elements, and/or components but do not preclude the presence or addition of one or more other features, integers, steps, operations, elements, components, and/or groups thereof. As used herein, the term “and/or” includes any one or all combinations of associated listed items.

Throughout the specification, when an element is referred to as “connected” or “accessed” to another element, it should be understood that the element may be directly connected or accessed to the other element but another element may exist between the element and the other element. When an element is referred to as “directly connected” or “directly accessed” to another component, it should be understood that another element may not exist between the element and the other element.

Throughout the specification, the terminology used is for the purpose of describing a particular embodiment only and is not intended to be limiting of the present disclosure. Singular expression includes plural expression unless the context clearly indicates otherwise.

It should be understood that one or more of methods below or one or more of aspects thereof may be executed by at least one controller. The term “controller” may refer to a hardware device including a memory and a processor. The memory is configured to store program instructions, and the processor is specifically programmed to execute the program instructions in order to perform one or more processes described in more detail below. The controller may control operations of units, modules, parts, devices, or the like, as described herein. It should be understood that the methods below may be executed by a device including a controller in conjunction with one or more other components, as should be appreciated by those having ordinary skill in the art.

When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

Hereinafter, an apparatus of diagnosing an engine system and a method thereof according to an embodiment is described in detail with reference to the drawings.

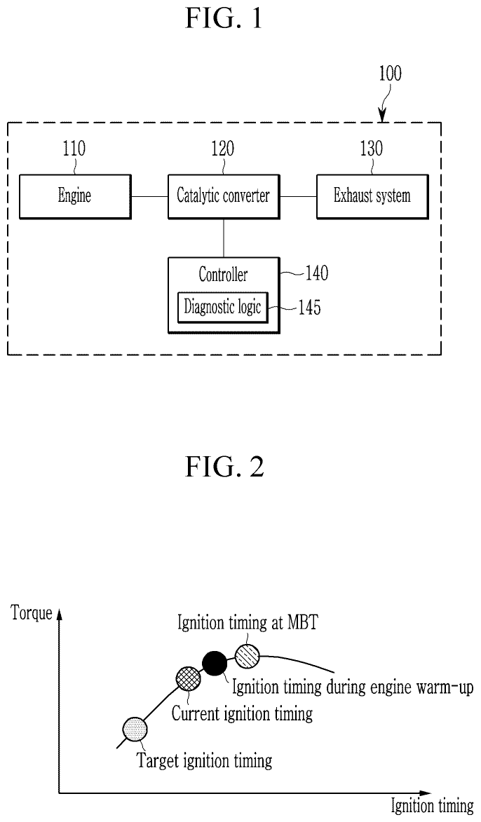

FIG. 1 schematically illustrates a configuration of an engine system according to an embodiment.

Referring to FIG. 1, an engine system 100 according to an embodiment may include an engine 110, a catalytic converter 120 that purifies an exhaust gas (or an emission) generated from the engine 110, an exhaust system 130 that discharges the exhaust gas purified through the catalytic converter 120, and a controller 140 that controls an overall operation of the engine system 100 according to state information of a vehicle.

The vehicle may be a gasoline engine vehicle, or a hybrid electric vehicle (HEV) or a plug-in HEV (PHEV) that operates an engine and a motor as a driving source.

The engine 110 may be a continuous variable valve timing (CVVT) engine, a double overhead camshaft (DOHC) engine, a continuous valve timing (CVT) engine, a gasoline direct injection (GDI) engine, a multi-point injection (MPI) engine, or the like that uses gasoline as fuel. However, an embodiment of the present disclosure may be applied to a common rail direct injection (CRDI) engine, a high direction turbo intercooler (HTI) engine, or a variable geometry turbocharger (VGT) engine that uses diesel as fuel through modification and/or change, an LPGX engine that uses gas as fuel through modification and/or change, or the like in addition to a gasoline engine.

The catalytic converter 120 may be installed between the engine 110 and the exhaust system 130 to purify CO, NOₓ, and a particulate material (PM) included in the exhaust gas through a catalytic reaction under a high-temperature condition.

The catalytic converter 120 may perform the catalytic reaction under a condition of reaching a light off temperature (LOT) having a high temperature. Accordingly, the catalytic converter 120 may be implemented as a warm-up catalytic converter (WCC) disposed close to the engine 110 to induce a rapid catalytic reaction after cold start, and may also be implemented as a three-way catalytic converter (TWC).

The exhaust system 130 may discharge an exhaust gas purified in the catalytic converter 120 into the atmosphere through an exhaust pipe and a muffler.

The controller 140 may perform catalyst heating (C/H) control for reducing the exhaust gas during the cold start of the engine 110, and may retard an ignition timing thereof for this purpose.

FIG. 2 shows a relationship between an ignition timing during the catalyst heating and torque of the engine according to an embodiment.

Referring to FIG. 2, when delay of the ignition timing is controlled for catalyst heating control, the controller 140 may delay an ignition timing at an idle state of the engine by idle torque reserve for the catalyst heating compared with an ignition timing at maximum brake torque (MBT). The idle torque reserve may refer to an amount delayed compared with the ignition timing at the MBT generating maximum torque.

The controller 140 may execute a diagnostic logic 145 that performs fault diagnosis on various parts applied for reducing the exhaust gas during cold start.

The controller 140 may execute the diagnostic logic 145 when a stabilization diagnosis condition of the vehicle including an off time of the engine is satisfied to determine a diagnostic index of ignition efficiency, and may compare the diagnostic index of the ignition efficiency with a set reference value to determine whether the engine system 100 is faulty (or abnormal).

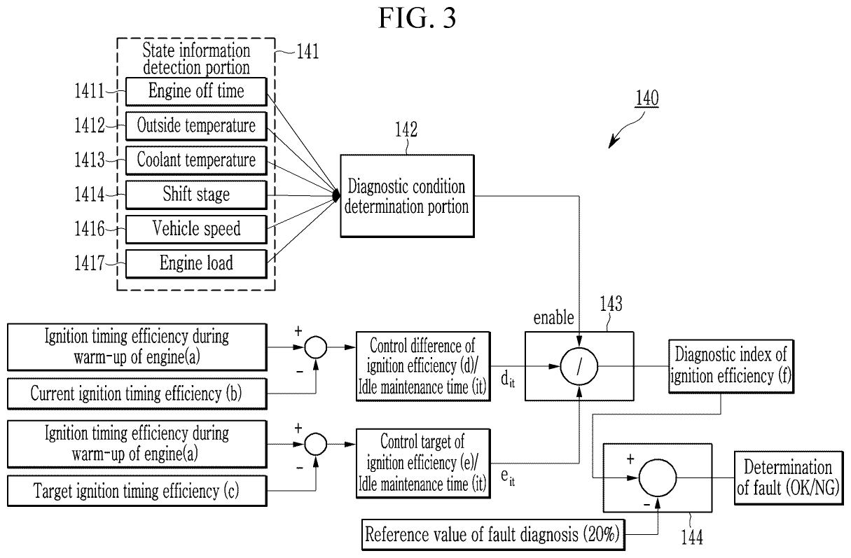

Hereinafter, a detailed configuration of the controller 140 according to an embodiment is described with reference to FIG. 3.

FIG. 3 illustrates a configuration of the engine system 100 of the controller according to an embodiment.

Referring to FIG. 3, the controller 140 according to the embodiment may include a state information detection portion 141, a diagnostic condition determination portion 142, an ignition efficiency calculation portion 143, and a fault diagnosis portion 144.

The state information detection portion 141 may detect state information from various sensors within the vehicle to transmit the state information to the diagnostic condition determination portion 142.

The state information may include the off time of the engine, an outdoor air temperature, a coolant temperature of the engine, a shift stage, a speed of the vehicle, and a load of the engine. The state information detection portion 141 may include an engine on/off sensor 1411, an outdoor air temperature sensor 1412, a coolant temperature sensor 1413, a shift stage sensor 1414, a vehicle speed sensor 1416, and an engine load sensor 1417.

The state information detection portion 141 may detect the state information of the vehicle. The state information may be collected from various sensors and controllers within the vehicle when a smart key is recognized within a cabin or a power source is connected to an electrical part (IG ON).

The diagnostic condition determination portion 142 may receive the state information from the state information detection portion 141, and may determine whether an entry condition for diagnosing the engine system 100 is satisfied. In this case, the entry condition may be in consideration of a stabilization condition of the vehicle, and when the entry condition is satisfied, the diagnostic logic 145 may be executed.

For example, based on the state information, the diagnostic condition determination portion 142 may start diagnosis of the engine system 100 when the off time of the engine is greater than or equal to a set time (e.g., 6 hours), the outdoor air temperature at start of the engine is greater than or equal to a first set temperature (e.g., −6.7 degrees Celsius), the coolant temperature of the engine is greater than the outdoor air temperature and is less than or equal to a second set temperature (e.g., 15 degrees Celsius) than the outdoor air temperature for determination of a cool down condition of the vehicle, the engine is in an idle state (e.g., the shift stage is an N stage or a P stage), the speed of the vehicle is less than or equal to a set speed (e.g., 1 MPH), and the load of the engine is less than or equal to a set torque.

Hereinafter, a matter that is considered when the engine system 100 is diagnosed is briefly described. Generally, a deviation of the ignition timing may occur when the catalyst heating is poor. However, the deviation of the ignition timing may occur even when the engine is off during driving due to lack of torque rather than the poor catalyst heating. Therefore, the ignition efficiency calculation portion 143 may execute a diagnostic logic for diagnosing a fault in the engine system 100 only when an idle state of the engine is maintained for a first time (T1) or more. For example, the first time (T1) may be set to 10 seconds.

In order to prevent misdiagnosis, when a target ignition timing is compared with a current ignition timing, the diagnostic logic for diagnosing the fault in the engine system may be executed by comparing average values thereof during an idle maintenance time of the first time (e.g., 10 seconds) or more.

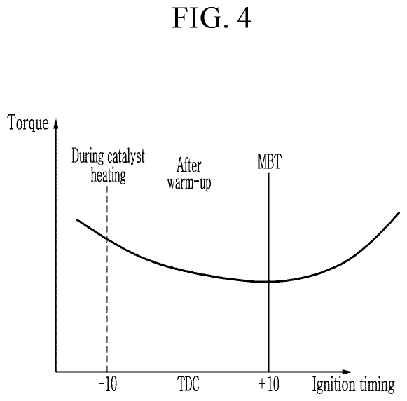

FIG. 4 is a graph for describing an ignition timing for diagnosing an engine system according to an embodiment.

Referring to FIG. 4, the ignition timing during warm-up of the engine may be an ignition timing in a state in which an idle RPM is stable after the engine is started, and may typically be 0 degrees (an ignition timing at TDC).

The ignition timing at the MBT may be an ignition timing for a maximum output of the engine, and may be an angle (e.g., +10 degrees) advanced from the ignition timing at the TDC.

The target ignition timing may be an ignition timing for the catalyst heating (C/H), and may be an angle (e.g., −10 degrees) delayed (or retarded) from the ignition timing at the TDC.

An idle time may be counted from an idle start time point after the engine is started for diagnosis of the engine system. If a first time (e.g., 10 seconds) elapses from the idle start time point, an entry condition may be satisfied. A second time (e.g., 30 seconds) from the idle start time point may be set as an idle maintenance time (it).

The ignition efficiency calculation portion 143 may determine an ignition efficiency diagnosis index (f) by dividing an ignition efficiency control difference average dᵢₜ while the engine is in an idle state by an ignition efficiency control target average eᵢₜ while the engine is in the idle state if the idle time is maintained for the first time (T1) or more after the engine is on.

In this case, the ignition efficiency calculation portion 143 may subtract a current ignition timing efficiency (b) from an ignition timing efficiency during warm-up of the engine (a) to determine an ignition efficiency control difference (d). In addition, the ignition efficiency calculation portion 143 may determine the ignition efficiency control difference average dᵢₜ while the engine is in the idle state by dividing the ignition efficiency control difference (d) by the idle maintenance time (it).

In addition, the ignition efficiency calculation portion 143 may determine an ignition efficiency control target (e) by subtracting a target ignition timing efficiency (c) from the ignition timing efficiency during the warm-up of the engine (a). In addition, the ignition efficiency calculation portion 143 may determine the ignition efficiency control target average eᵢₜ while the engine is in the idle state by dividing the ignition efficiency control target (e) by the idle maintenance time (it).

If the ignition efficiency diagnosis index (f) derived from the ignition efficiency calculation portion 143 is less than a fault diagnosis reference value (e.g., 20%), the fault diagnosis portion 144 may determine that the engine system is faulty. If the ignition efficiency diagnosis index (f) is greater than or equal to the fault diagnosis reference value (e.g., 20%), the fault diagnosis portion 144 may determine that the engine system is normal.

The controller 140 may be implemented as one or more processors operated by a set program, and the set program may be programmed to perform each step of a method of diagnosing the engine system according to an embodiment.

The method of diagnosing the engine system is described in more detail with reference to the following drawings.

The elements of the controller 140 according to an embodiment of the present disclosure described above with reference to FIG. 3 have been described by subdividing the elements according to a function, but may be integrated into one.

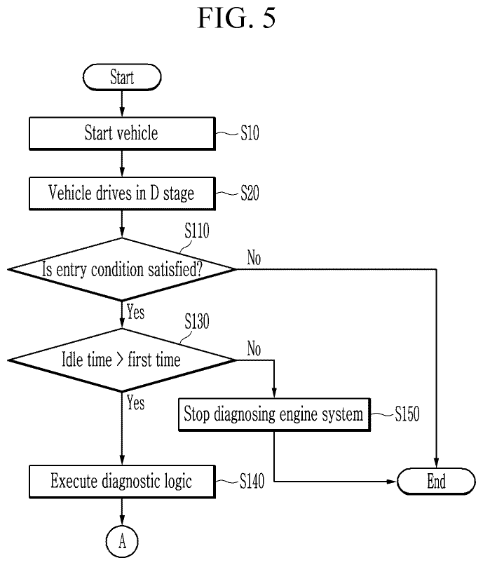

FIGS. 5 to 7 are flowcharts illustrating the method of diagnosing the engine system according to an embodiment.

First, a method for entering diagnosis of the engine system according to the stabilization condition of the vehicle is described with reference to FIG. 5.

The vehicle may be started by a driver (S10), and the vehicle may be driven in a driving stage (e.g., a D stage) (S20).

The controller 140 may determine whether a sudden change in the ignition timing occurs by determining a change in the ignition timing at idle of the engine to diagnose the engine system. To prevent misdiagnosis due to a disturbance factor, the controller 140 may execute a diagnostic logic for diagnosing fault of the engine system only when the stabilization condition of the vehicle is satisfied.

The controller 140 may determine whether the diagnostic logic for diagnosing the engine system is executed by checking whether the stabilization condition of the vehicle (i.e., the entry condition for diagnosing the engine system) is satisfied (S110).

For example, if the off time of the engine is greater than or equal to a set time (e.g., 6 hours), the outdoor air temperature at start of the engine is greater than or equal to a first set temperature (e.g., −6.7 degrees Celsius), the coolant temperature of the engine is less than or equal to a second set temperature (e.g., 15 degrees Celsius) than the outdoor air temperature for determination of a cool down condition of the vehicle, the engine is in an idle state (e.g., the shift stage is an N stage or a P stage), the speed of the vehicle is less than or equal to a set speed (e.g., 1 MPH), and the load of the engine is less than or equal to a set torque (YES in S100), the controller 140 may determine that the stabilization condition of the vehicle is satisfied and may execute the diagnostic logic of the engine system.

Additionally, the controller 140 may determine whether an idle time of the engine exceeds the first time (T1) (e.g., 10 seconds) (S130).

In this case, when the idle time of the engine exceeds the first time (T1) (Yes in S130), the controller 140 may execute a diagnostic logic that determines whether the engine system is abnormal (S140).

When the entry condition is not satisfied, the controller 140 may end the diagnostic logic that determines whether the engine system is abnormal without performing the diagnostic logic.

Additionally, when the idle time does not exceed 10 seconds even if the entry condition is satisfied (No in S130), the controller 140 may stop diagnosing the engine system (S150).

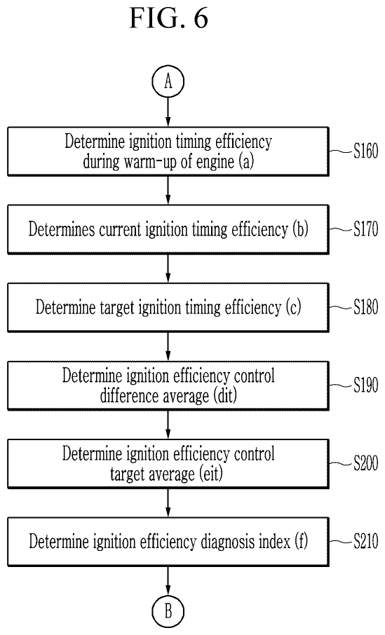

Next, the diagnostic logic for diagnosing the engine system according to an embodiment is described with reference to FIG. 6.

The controller 140 may determine the ignition timing efficiency during the warm-up of the engine (a) by dividing the ignition timing during the warm-up of the engine by the ignition timing at the MBT (S160). The ignition timing efficiency during the warm-up of the engine (a) may refer to an efficiency when an efficiency of the engine is highest, and may be stored in advance in the controller 140. For example, the ignition timing during the warm-up of the engine may refer to a timing when a difference between the outdoor air temperature and the coolant temperature of the vehicle is greatest.

In other words, the ignition timing efficiency during the warm-up of the engine (a) may be determined by Equation 1 below.

$$The ignition timing efficiency during the warm - up of the engine ( a ) = The ignition timing during the warm - up of the engine / The ignition timing at the MBT \qquad [ Equation 1 ]$$

The controller 140 may determine the current ignition timing efficiency (b) by dividing the current ignition timing by the ignition timing at the MBT (S170).

In other words, the current ignition timing efficiency (b) may be determined by Equation 2 below.

$$The current ignition timing efficiency ( b ) = The current ignition timing / The ignition timing at the MBT \qquad [ Equation 2 ]$$

The controller 140 may determine the target ignition timing efficiency (c) by dividing the target ignition timing by the ignition timing at the MBT (S180).

In other words, the target ignition timing efficiency (c) may be determined by Equation 3 below.

$$The target ignition timing efficiency ( c ) = The target ignition timing / The ignition timing at the MBT \qquad [ Equation 3 ]$$

The controller 140 may divide a value (d) obtained by subtracting the current ignition timing efficiency (b) from the ignition timing efficiency during the warm-up of the engine (a) by the idle maintenance time (it) to determine the ignition efficiency control difference average dᵢₜ while the engine is in the idle state (S190).

In other words, the ignition efficiency control difference average dᵢₜ may be determined by Equation 4 below.

$$The ignition efficiency control difference average {d}_{it} = ( a - b ) / it \qquad [ Equation 4 ]$$

The controller 140 may determine the ignition efficiency control target average eᵢₜ while the engine is in the idle state by dividing a value (e) obtained by subtracting the target ignition timing efficiency from the ignition timing efficiency during the warm-up of the engine by the idle maintenance time (it) (S200).

In other words, the ignition efficiency control target average eᵢₜ may be determined by Equation 5 below.

$$The ignition efficiency control target average {e}_{it} = ( a - c ) / it \qquad [ Equation 5 ]$$

The controller 140 may determine the ignition efficiency diagnosis index (f) by dividing the ignition efficiency control difference average dᵢₜ by the ignition efficiency control target average eᵢₜ (S210).

In other words, the ignition efficiency diagnosis index (f) may be determined by Equation 6 below.

$$The ignition efficiency diagnosis index ( f ) = {d}_{it} / {e}_{it} \qquad [ Equation 6 ]$$

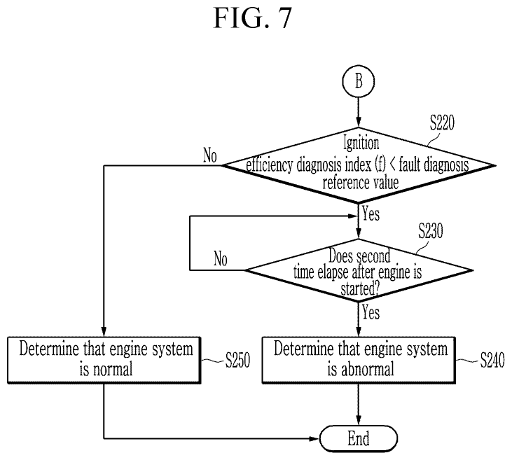

Referring to FIG. 7, the controller 140 may compare the ignition efficiency diagnosis index with the fault diagnosis reference value (e.g., 20%) (S220).

In this case, the controller 140 may determine whether a second time (T2) has elapsed after the engine is started when the ignition efficiency diagnosis index is less than the fault diagnosis reference value (e.g., 20%) (Yes in S220) (S230). When the second time (T2) has elapsed (Yes in S230), the controller 140 may determine that the engine system is abnormal (S240). The second time (T2) may be set to 30 seconds that is longer than the first time (e.g., 10 seconds). Additionally, the controller 140 may provide an alarm to the driver by displaying abnormality in the engine system through a cluster or a display within the vehicle.

For example, the controller 140 may determine that abnormality occurs in an injector and/or a spark plug that has a major influence on the ignition timing, and may notify the driver through the display or the like that the abnormality occurs in the injector and/or the spark plug and the abnormal injector and/or the abnormal spark plug requires maintenance.

In another example, the controller 140 may determine that engine system is abnormal and identify the specific component that is malfunctioning such as a spark plug.

In another example, the controller 140 may determine that engine system is abnormal and may then adjust engine parameters, such as temporarily modifying ignition timing or fuel injection patterns to maintain combustion stability and prevent further engine damage.

In yet another example, the controller 140 may determine that the engine system is abnormal and may log the abnormality and related operational data in memory for later analysis or maintenance reference.

If the ignition efficiency diagnosis index is greater than or equal to the fault diagnosis reference value (No in S220), the controller 140 may determine that the engine system is normal (S250). For example, the engine system may be considered normal when all monitored parameters, including ignition efficiency, fuel injection timing, and sensor readings, are within their respective predefined thresholds, and no faults, failures, or abnormal operating conditions are detected.

Thus, the embodiment may determine whether the engine system is faulty based on the ignition efficiency diagnosis index according to catalyst heating control during the cold start of the vehicle. Therefore, the embodiment may diagnose fault (or abnormality) between two or more parts of the engine system even if there is no fault of an individual part.

Additionally, the embodiment may perform fault diagnosis only when various stabilization conditions of the vehicle including the off time of the engine are satisfied so that it prevents misdiagnosis due to the disturbance factor.

Additionally, the embodiment may provide a self-diagnosis logic of the engine system that performs the catalyst heating (C/H) control during the cold start so that it copes with enhanced emission regulation (ACC-2).

Although the embodiment has been described above, the disclosed content is not limited to the above-described embodiment, and various other changes are possible.

For example, the above-described embodiment has been described on an assumption that the diagnostic apparatus is integrated into the controller 140 of the engine system 100 to perform self-diagnosis. However, the disclosed embodiment is not limited thereto, and the diagnostic apparatus may be integrated into some functions of an electronic control unit (ECU) and/or a hybrid control unit (HCU), or may be implemented as a separate diagnostic apparatus for the engine system 100.

The disclosed embodiment is not implemented only through the apparatus and/or the method described above, but may be implemented through a program for realizing a function corresponding to the configuration of the disclosed embodiment, a recording medium in which the program is recorded, or the like, and the implementation may be easily implemented by an expert in the technical field who belongs to the embodiment disclosed from the description of the embodiment described above.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

1. An apparatus for diagnosing an engine system of a vehicle, the apparatus comprising:
a state information detection portion configured to detect state information of the vehicle;
a diagnostic condition determination portion configured to determine whether an entry condition diagnosing the engine system is satisfied based on the state information;
an ignition efficiency calculation portion configured to determine an ignition efficiency diagnosis index by dividing an ignition efficiency control difference average while an engine is in an idle state by an ignition efficiency control target average while the engine is in the idle state when an idle time of the engine is maintained for 1 hour or more after the engine is started; and
a fault diagnosis portion configured to determine that the engine system is abnormal when the ignition efficiency diagnosis index is less than a set fault diagnosis reference value.

2. The apparatus of claim 1, wherein the state information comprises an off time of the engine, an outdoor air temperature, a coolant temperature of the engine, a shift stage, a speed of the vehicle, and a load of the engine.

3. The apparatus of claim 2, wherein the diagnostic condition determination portion is further configured to start diagnosis of the engine system when the off time of the engine is greater than or equal to a set time, the outdoor air temperature at a start of the engine is greater than or equal to a first set temperature, the coolant temperature of the engine is greater than the outdoor air temperature, the coolant temperature of the engine is less than or equal to a second set temperature than the outdoor air temperature, the engine is in the idle state, the speed of the vehicle is less than or equal to a set speed, and the load of the engine is less than or equal to a set torque.

4. The apparatus of claim 1, wherein the ignition efficiency calculation portion is further configured to:
determine an ignition efficiency control difference by subtracting a current ignition timing efficiency from an ignition timing efficiency during warm-up of the engine; and
determine the ignition efficiency control difference average during the idle state of the engine by dividing the ignition efficiency control difference by an idle maintenance time.

5. The apparatus of claim 1, wherein the ignition efficiency calculation portion is further configured to:
determine an ignition efficiency control target by subtracting a target ignition timing efficiency from an ignition timing efficiency during warm-up of the engine; and
determine the ignition efficiency control target average during the idle state of the engine by dividing the ignition efficiency control target by an idle maintenance time.

6. The apparatus of claim 1, wherein the fault diagnosis portion is further configured to:
determine that the engine system is faulty when the ignition efficiency diagnosis index is less than the fault diagnosis reference value; and
determine that the engine system is normal when the ignition efficiency diagnosis index is greater than or equal to the fault diagnosis reference value.

7. A method of diagnosing an engine system of a vehicle, the method comprising:
determining, by a controller, whether an entry condition diagnosing the engine system is satisfied based on state information of the vehicle;
executing, by the controller, a diagnostic logic diagnosing the engine system when the entry condition is satisfied and an idle time after an engine is started exceeds a first time;
determining, by the controller, an ignition efficiency diagnosis index by dividing an ignition efficiency control difference average while the engine is in an idle state by an ignition efficiency control target average while the engine is in the idle state; and
determining, by the controller, that the engine system is abnormal when the ignition efficiency diagnosis index is less than a set fault diagnosis reference value.

8. The method of claim 7, wherein the entry condition is determined to be satisfied when:
an off time of the engine is greater than or equal to a set time;
an outdoor air temperature is greater than or equal to a first set temperature;
a coolant temperature of the engine is greater than the outdoor air temperature;
the coolant temperature of the engine is less than or equal to a second set temperature than the outdoor air temperature;
the engine is in the idle state;
a speed of the vehicle is less than or equal to a set speed; and
a load of the engine is less than or equal to a set torque.

9. The method of claim 7, wherein the diagnostic logic is terminated when the idle time does not exceed the first time.

10. The method of claim 7, wherein the determining of the ignition efficiency diagnosis index comprises:
determining an ignition efficiency control difference average during the idle state by dividing a value obtained by subtracting a current final ignition timing efficiency from an ignition timing efficiency during warm-up of the engine by an idle maintenance time; and
determining an ignition efficiency control target average during the idle state by dividing a value obtained by subtracting a final heating ignition timing efficiency target value from the ignition timing efficiency during the warm-up of the engine by the idle maintenance time.

11. The method of claim 10, wherein the determining of the ignition efficiency diagnosis index further comprises:
determining the ignition timing efficiency during the warm-up of the engine by dividing an ignition timing during the warm-up of the engine by an ignition timing at maximum brake torque;
determining the current final ignition timing efficiency by dividing a current ignition timing by the ignition timing at the maximum brake torque; and
determining the final heating ignition timing efficiency target value by dividing a target ignition timing by the ignition timing at the maximum brake torque.

12. The method of claim 7, wherein the determining that the engine system is abnormal comprises:
determining that the engine system is abnormal and providing an alarm to a driver when a second time longer than the first time elapses after the engine is started.

13. The method of claim 7, wherein the engine system is determined to be normal when the ignition efficiency diagnosis index is greater than or equal to the fault diagnosis reference value.

14. An engine system of a vehicle, the system comprising:
an engine;
a catalytic converter configured to purify an exhaust gas generated from the engine;
an exhaust system configured to discharge the exhaust gas purified through the catalytic converter; and
a controller configured to:
determine whether an entry condition diagnosing the engine system is satisfied based on state information of the vehicle,
execute a diagnostic logic diagnosing the engine system when the entry condition is satisfied and an idle time after the engine is started exceeds a first time,
determine an ignition efficiency diagnosis index by dividing an ignition efficiency control difference average while the engine is in an idle state by an ignition efficiency control target average while the engine is in the idle state, and
determine that the engine system is abnormal when the ignition efficiency diagnosis index is less than a set fault diagnosis reference value.

15. The system of claim 14, wherein the entry condition is determined to be satisfied when:
an off time of the engine is greater than or equal to a set time;
an outdoor air temperature is greater than or equal to a first set temperature;
a coolant temperature of the engine is greater than the outdoor air temperature;
the coolant temperature of the engine is less than or equal to a second set temperature than the outdoor air temperature;
the engine is in the idle state;
a speed of the vehicle is less than or equal to a set speed; and
a load of the engine is less than or equal to a set torque.

16. The system of claim 14, wherein the diagnostic logic is terminated when the idle time does not exceed the first time.

17. The system of claim 14, wherein the controller is further configured to:
determine an ignition efficiency control difference average during the idle state by dividing a value obtained by subtracting a current final ignition timing efficiency from an ignition timing efficiency during warm-up of the engine by an idle maintenance time; and
determine an ignition efficiency control target average during the idle state by dividing a value obtained by subtracting a final heating ignition timing efficiency target value from the ignition timing efficiency during the warm-up of the engine by the idle maintenance time.

18. The system of claim 17, wherein the controller is further configured to:
determine the ignition timing efficiency during the warm-up of the engine by dividing an ignition timing during the warm-up of the engine by an ignition timing at maximum brake torque;
determine the current final ignition timing efficiency by dividing a current ignition timing by the ignition timing at the maximum brake torque; and
determine the final heating ignition timing efficiency target value by dividing a target ignition timing by the ignition timing at the maximum brake torque.

19. The system of claim 14, wherein the controller is further configured to:
determine that the engine system is abnormal; and
provide an alarm to a driver when a second time longer than the first time elapses after the engine is started.

20. The system of claim 14, wherein the engine system is determined to be normal when the ignition efficiency diagnosis index is greater than or equal to the fault diagnosis reference value.
